(19) United States
(12) Patent Application Publication
(10) Pub. No.: US 2006/0007237 A1
(43) Pub. Date: Jan. 12, 2006

(54) Apparatuses and methods for sharing a memory between display data and compressed display data

(76) Inventor: Eric Jeffrey, Richmond (CA)

Correspondence Address: EPSON RESEARCH AND DEVELOPMENT INC;INTELLECTUAL PROPERTY DEPT, 150 RIVER OAKS PARKWAY, SUITE 225, SAN JOSE, CA, 95134, US

(21) Appl. No.: 10/886,873

(22) Filed: Jul. 8, 2004

(51) Int. Cl. G06F 15/167; G06T 9/00

(52) U.S. Cl. 345/541; 345/555

(57) ABSTRACT

A display controller for sharing a memory between display data and compressed display data is provided. The display controller includes the memory, and the memory has a memory block configured to alternate between storing the display data and storing the compressed display data. A codec in communication with the memory block is also included in the display controller, whereby the codec is configured to generate the compressed display data from the display data stored in the first memory block. A hardware implemented method and an apparatus for sharing a memory between display data and compressed display data are also described.

### CROSS REFERENCE TO RELATED APPLICATIONS

This application is related to U.S. patent Publication No. 2002/0057265, filed on Oct. 23, 2001, and entitled “Display Driver, and Display Unit and Electronic Instrument Using the Same.” The disclosure of this application, is incorporated herein by reference in its entirety for all purposes.

This application is related to U.S. patent Publication No. 2002/0018058, filed on Jul. 25, 2001, and entitled “RAM-Incorporated Driver, and Display Unit and Electronic Equipment Using the Same.” The disclosure of this application, is incorporated herein by reference in its entirety for all purposes.

### BACKGROUND OF THE INVENTION

1. Field of the Invention

This invention relates generally to computer graphics and, more particularly, to methods and apparatuses for utilizing memory in a display controller.

2. Description of the Related Art

Many portable computing devices now include cameras. With cameras, these portable computing devices can record and store photographic images in digital form that can be stored for later retrieval. The recording and storage of photographic images require these portable computing devices to encode and decode the photographic images. FIG. 1 is a schematic diagram of a conventional display controller included within a portable computing device that encodes photographic images taken from a camera. As shown in FIG. 1, conventional display controller 120 includes memory 102 that is divided into separate display buffer 122 block, line buffer 124 block, and Joint Photographic Experts Group (JPEG) buffer 106 block. Display buffer 122 stores the display data received from camera 104 and line buffer 124 stores blocks of display data for encoding by JPEG coder/decoder (codec) 108. Subsequently, JPEG codec 108 compresses the display data and temporarily stores the compressed display data in JPEG buffer 106 for later retrieval by central processing unit (CPU) 109.

The division of memory 102 into three separate blocks 106, 124, and 122 requires that memory 102 accommodate both the display data and the compressed display data. Since these portable computing devices typically have limited power, memory, and computing capability because of their small size and portable nature, the added circuitry to accommodate the three separate blocks slows down the processing and encoding of photographic images.

In view of the foregoing, there is a need to reduce the number of blocks in memory, and ultimately to reduce the size of memory in display controllers.

### SUMMARY OF THE INVENTION

Broadly speaking, the present invention fills these needs by providing hardware implemented methods and an apparatuses for sharing a memory between display data and compressed display data. It should be appreciated that the present invention can be implemented in numerous ways, including as a method, a system, or a device. Several inventive embodiments of the present invention are described below.

In accordance with a first aspect of the present invention, a hardware implemented method for sharing a display buffer between display data and compressed display data in a display controller is provided. In this hardware implemented method, display data is received into the display buffer. The display data is then sent for display on a random access memory (RAM)-integrated panel and sent to a codec for compression. The codec is configured to compress the display data to produce the compressed display data. Thereafter, the display data in the display buffer is overwritten with the compressed display data prior to receiving a next display data.

In accordance with a second aspect of the present invention, a display controller having a shared memory is provided. The display controller includes a memory, and the memory has a first memory block configured to alternate between storing display data and storing compressed display data. A codec in communication with the first memory block is also included in the display controller, whereby the codec is configured to generate the compressed display data from the display data stored in the first memory block.

In accordance with a third aspect of the present invention, an apparatus is provided. The display controller includes circuitry for receiving display data into a display buffer, circuitry for sending the display data for display on a RAM-integrated panel, circuitry for sending the display data to a codec for compression, and circuitry for overwriting the display data in the display buffer with the compressed display data prior to receiving a next display data. The apparatus additionally includes a central processing unit (CPU) in communication with the display controller and an image capture device in communication with the display controller.

Other aspects and advantages of the invention will become apparent from the following detailed description, taken in conjunction with the accompanying drawings, illustrating by way of example the principles of the invention.

### BRIEF DESCRIPTION OF THE DRAWINGS

The present invention will be readily understood by the following detailed description in conjunction with the accompanying drawings, and like reference numerals designate like structural elements.

FIG. 1 is a schematic diagram of a conventional display controller included within a portable computing device that encodes photographic images taken from a camera.

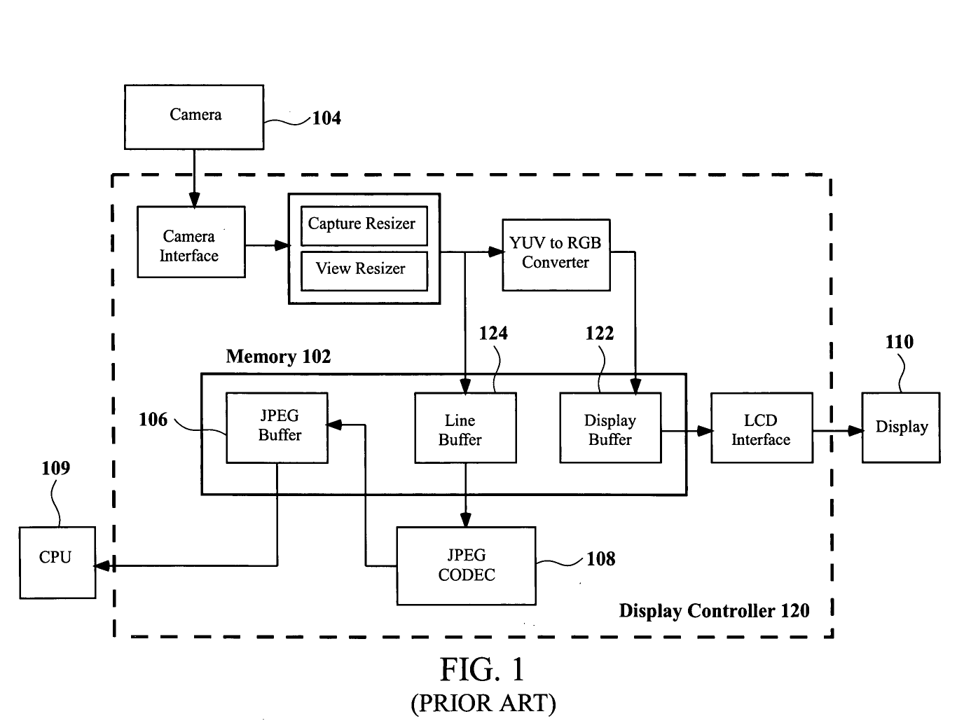

FIG. 2 is a flowchart diagram of a high level overview of a hardware implemented method for sharing a display buffer between display data and compressed display data in a display controller, in accordance with one embodiment of the present invention.

FIG. 3 is a simplified schematic diagram of an apparatus for sharing a display buffer between display data and compressed display data, in accordance with one embodiment of the present invention.

FIG. 4 is a more detailed schematic diagram of the display controller shown in FIG. 3, in accordance with one embodiment of the present invention.

FIG. 5 is another detailed schematic diagram of the display controller shown in FIG. 3, in accordance with one embodiment of the present invention.

### DETAILED DESCRIPTION OF THE PREFERRED EMBODIMENTS

An invention is described for hardware implemented methods and apparatuses for sharing a memory between display data and compressed data. It will be obvious, however, to one skilled in the art, that the present invention may be practiced without some or all of these specific details. In other instances, well known process operations have not been described in detail in order not to unnecessarily obscure the present invention.

The embodiments described herein provide an apparatus, display controllers, and hardware implemented methods for sharing a memory between display data and compressed display data. Essentially, a buffer used by the codec is eliminated by moving that buffer's functionality into a display buffer without increasing the size of the display buffer. As will be explained in more detail below, to accommodate the buffer's functionality, an embodiment of the present invention has the display buffer alternate between storing the display data and storing the compressed display data.

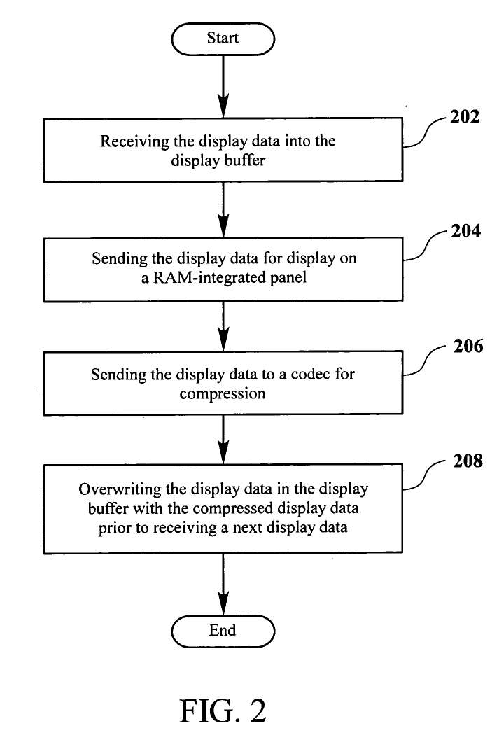

FIG. 2 is a flowchart diagram of a high level overview of a hardware implemented method for sharing a display buffer between display data and compressed display data in a display controller, in accordance with one embodiment of the present invention. Starting in operation 202, the display data is received into the display buffer. Thereafter, in operation 204, the display data is sent to a random access memory (RAM)-integrated panel for display. The display data is then sent to a codec for compression in operation 206, whereby the codec is configured to compress the display data to generate the compressed display data. It should be noted that the terms “compress” and “encode” are the same and can be used interchangeably. In operation 208, the display data stored in the display buffer is then overwritten with the compressed display data prior to receiving a next display data. Each of the operations 202, 204, 206, and 208 repeats for each successive frame of display data from an image capture device.

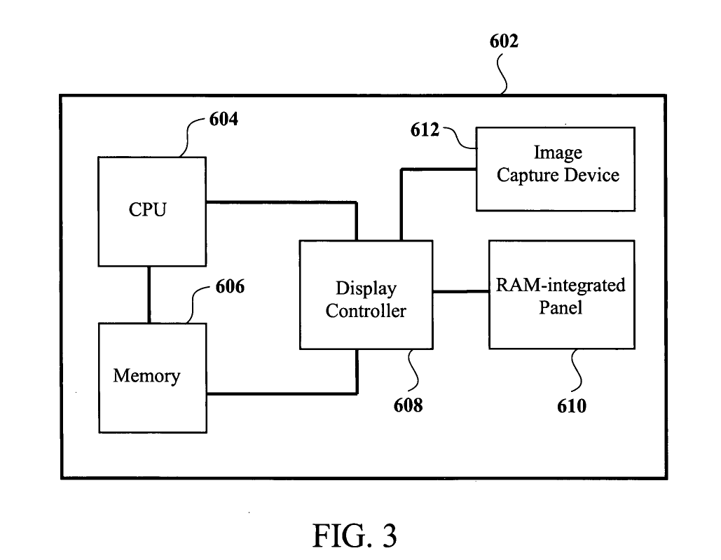

FIG. 3 is a simplified schematic diagram of an apparatus for sharing a display buffer between display data and compressed display data, in accordance with one embodiment of the present invention. Apparatus 602 includes any suitable type of computing device. For example, apparatus 602 may be a personal digital assistant, a cell phone, a web tablet, a pocket personal computer, etc. As shown in FIG. 3, apparatus 602 includes central processing unit (CPU) 604, memory 606, display controller 608, RAM-integrated panel 610, and image capture device 612. Display controller 608 is in communication with CPU 604, memory 606, image capture device 612, and RAM-integrated panel 610. One skilled in the art will appreciate that while CPU 604, memory 606, and display controller 608 are illustrated as being interconnected, each of these components may be in communication through a common bus.

Image capture device 612 records photographic images as display data and outputs the display data to display controller 608. Examples of image capture device 612 include cameras, digital cameras, video cameras, digital video cameras, etc.

Examples of memory 606 include static access memory (SRAM), dynamic random access memory (DRAM), etc. In one embodiment, the display data from image capture device 612 is stored in a memory included within display controller 609. In another embodiment, memory 606, which is in communication with display controller 608, may also be configured to store the display data.

RAM-integrated panel 610 may include RAM-integrated liquid crystal displays (LCD), RAM-integrated thin-film transistor (TFT) displays, RAM-integrated cathode ray tube (CRT) monitors, RAM-integrated televisions, etc. One skilled in the art will appreciate that RAM-integrated panels include integrated chip display drivers with built-in random access memory (RAM) that drives a display section based on still-display data and moving-display data. In effect, display data may be stored in the built-in RAM. For more information on RAM-integrated panels, reference may be made to U.S. patent Publication No. 2002/0057265, entitled “Display Driver, and Display Unit and Electronic Instrument Using the Same,” and to U.S. patent Publication No. 2002/0018058, entitled “RAM-Incorporated Driver, and Display Unit and Electronic Equipment Using the Same,” and which are herein incorporated by reference.

The functionality described above for sharing the display buffer between display data and compressed display data is incorporated into display controller 608. In one embodiment, display controller 608 includes the circuitry for receiving the display data into the display buffer, circuitry for sending the display data for display on RAM-integrated panel 610, circuitry for sending the display data to a codec for compression, and circuitry for overwriting the display data in the display buffer with the compressed display data prior to receiving a next display data.

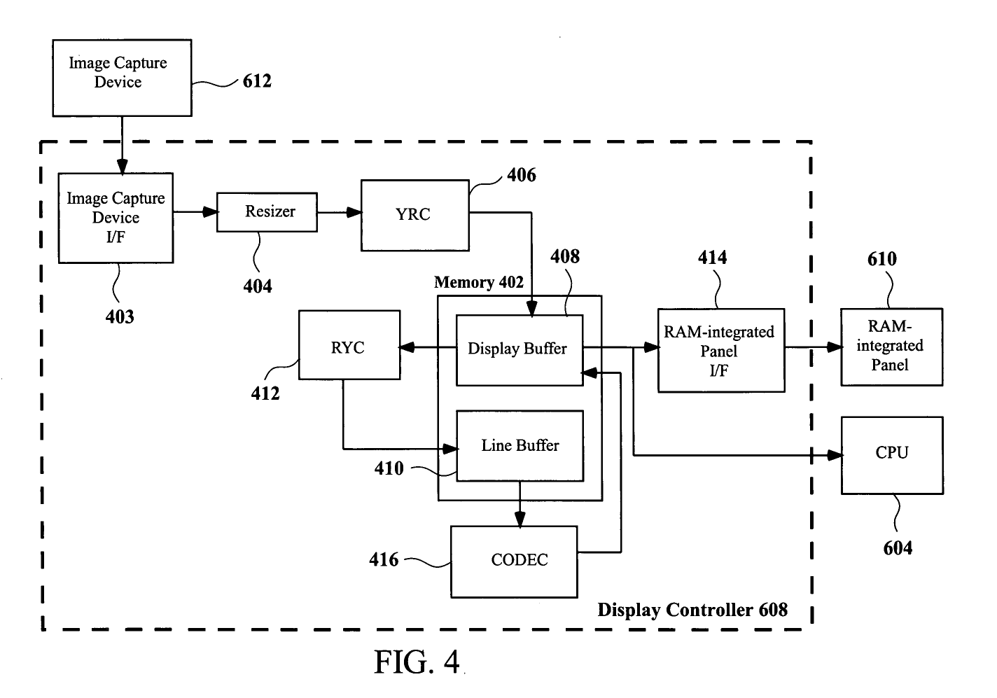

FIG. 4 is a more detailed schematic diagram of the display controller shown in FIG. 3, in accordance with one embodiment of the present invention. As shown in FIG. 4, display controller 608 includes memory 402 that is in communication with codec 416. Memory 402 includes any suitable type of memory such as SRAM, DRAM, etc. Codec 416 includes any suitable type of codec that compresses display data. Exemplary codec 416 includes a Joint Photographic Experts Group (JPEG) codec, a Graphic Interchange Format (GIF) codec, a Portable Network Graphics (PNG) codec, etc. In one embodiment, memory 402 is divided into separate display buffer 408 and line buffer 410 blocks. As will be explained in more detail below, codec 416 is in communication with display buffer 408 and the display buffer is configured to alternate between storing the display data and storing the compressed display data. On the other hand, line buffer 410 is configured to store a portion of the display data. One in the skill will appreciate that some codecs require a line buffer because these codecs cannot encode lines of display data but encode blocks of display data instead. For example, a JPEG codec is configured to encode a block that consists of eight lines of display data with eight pixels per line.

Furthermore, display buffer 408 is in communication with RAM-integrated panel interface 414, Y, Cb, and Cr (YUV) to red, green, blue (RGB) converter 406, line buffer 410, and central processing unit (CPU) 604. As shown in FIG. 4, RGB to YUV converter 412 is also connected between display buffer 408 and line buffer 410. However, RGB to YUV converter 412 is optional, and, in one embodiment, may be excluded depending on the type of input format required by codec 416. One skilled in the art would appreciate that RAM-integrated interface 414 provides the interface to RAM-integrated panel 610, and YUV to RGB converter 406 and RGB to YUV converter 412 convert display data to either YUV or RGB format. Additionally, YUV to RGB converter 406 is in communication with a single resizer 404 and, in turn, the resizer is in communication with image capture device interface 403. As is well known to those skilled in the art, resizer 404 resizes the display data to the appropriate size of RAM-integrated display 610 or codec 416, and image capture device interface 403 provides the interface to image capture device 612.

As shown in FIG. 4, display data sent from image capture device 612 is first resized by resizer 404. Depending on the use of display data, resizer 404 either resizes display data to a size appropriate for RAM-integrated panel 610 or codec 416. For example, in one embodiment, when a user is viewing the image on RAM-integrated panel 610, the display data is not compressed by codec 416. As such, during viewing, resizer 404 resizes the display data from image capture device 612 to a size appropriate for RAM-integrated panel 610. On the other hand, when the user wants to capture the image, the display data from image capture device 612 is sent to codec 416 for compression. Here, resizer 404 resizes the display data according to a size appropriate for codec 416. In one embodiment, the sizes required by RAM-integrated panel 610 and codec 416 are stored in a register. Depending on whether the user wants to view or capture the display data, resizer 404 retrieves the appropriate size from the register and resizes the display data from image capture device 612 accordingly.

After the display data is resized by resizer 404, the display data, which is in YUV format, is converted to RGB format by YUV to RGB converter 406. The display data is then received into display buffer 408 for temporary storage and thereafter, the display data is sent to RAM-integrated panel interface 414 for display on RAM-integrated panel 610. Since the present invention utilizes RAM-integrated panel 610, the RAM-integrated panel allows storage of a complete frame of display data. As a result, the complete frame of display data may be completely transferred from display buffer 408 to RAM-integrated panel 610, as opposed to a conventional display controller needing to continuously refresh a panel without RAM-integration.

In one embodiment, the display data in display buffer 408 is then sequentially sent to codec 416 for compression. As shown in FIG. 4, when display data is sent to codec 416, the display data in RGB format is first converted to YUV format by RGB to YUV converter 412, in accordance with one embodiment of the present invention. Here, the display data is not temporarily stored in line buffer 410 before being compressed by codec 416. As discussed above, line buffer 410 is used by codec 416 for temporary storage of a portion of the display data. However, in this embodiment, the complete frame of display data is already stored in display buffer 408. Thus, codec 416 may retrieve blocks (e.g., 8×8 blocks) of display data directly from display buffer 408 in any suitable order. Nonetheless, line buffer 410 may be required when a data source is a live stream and the display data is encoded in real time.

After codec 416 compresses the display data, the compressed display data is then sent back to display buffer 408. Depending on the type of codec used, the compressed display data may be formatted as JPEG data, GIF data, PNF data, etc. As discussed above, the complete frame of display data has already been sent to RAM-integrated panel 610 for display. Accordingly, between the time after the display data is sent out to RAM-integrated panel 610 for display and before the arrival of a next frame of display data, the display data stored in display buffer 408 has already been accessed and is not needed by display controller 608. Codec 416 can therefore temporarily store the compressed display data in display buffer 408 prior to the display buffer receiving a next frame of display data from image capture device 612. As a result, codec 416 compresses the display data and overwrites the display data stored in display buffer 408 with the compressed display data. CPU 604 then retrieves the compressed display data from display buffer 408 prior to the display buffer receiving a next frame of display data from image capture device 612.

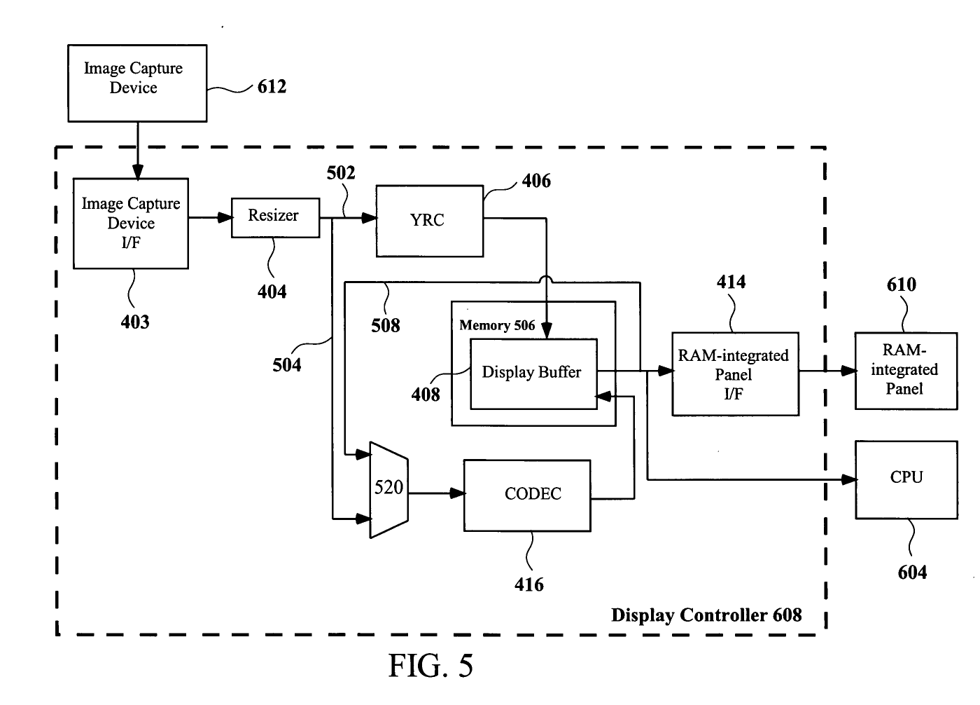

FIG. 5 is another detailed schematic diagram of the display controller shown in FIG. 3, in accordance with one embodiment of the present invention. As shown in FIG. 5, display controller includes two different communication paths 502 and 504. Along communication path 504, the display data outputted by resizer 404 is directly sent to codec 416. As a result, the display data is immediately compressed by codec 416 and stored in display buffer 408 for retrieval by CPU 604. In effect, communication path 504 allows the display data to be directly encoded and recorded without being displayed by RAM-integrated panel 610. On the other hand, along communication path 502, the display data outputted by resizer 404 is sent to display buffer 408, and the display data is then sent from display buffer 408 to RAM-integrated panel 610 for display and to codec 416 for compression. The select signal for multiplexer 520 is user defined and allows the user to choose whether to directly encode display data from image capture device 612 or from display buffer 408. Communication path 504 is optional, and if communication path 504 is not included, then multiplexer 520 is not required and display buffer 408 is directly connected to codec 416.

As shown in FIG. 5, display controller 608 includes memory 506 that is also in communication with codec 416. However, unlike the display controller of FIG. 4, this embodiment includes memory 506 that comprises of a single display buffer 408 block. Memory 506 is not further divided to create a line buffer because some codecs can encode lines of display data and, as such, do not require the line buffer.

If the user selects to encode from display buffer 408, the display data outputted from resizer 404 is sent to display buffer 408 for storage along communication path 502. Thereafter, display buffer 408 sends the display data to codec 416 along communication path 508. Instead of sending the display data to codec 416 after the display data is sent to RAM-integrated panel 610 for display, communication path 508 allows the display data to be sent to the RAM-integrated panel and the codec simultaneously. As such, instead of sending out the display data twice, the display data is sent out once in this embodiment. Furthermore, this embodiment of display controller 608 does not have a RGB to YUV converter connected between display buffer 408 and codec 416 because some codecs do not require the input display data to be in YUV format.

In this case, unlike sending out the display data to RAM-integrated panel 610 and codec 416 sequentially, sending the display data to the RAM-integrated panel and the codec simultaneously may result in the codec overwriting portions of the display data before the complete frame of display data is sent to the RAM-integrated panel for display. However, codec 416 will not overwrite the portions of display data that has not been accessed because the compressed display data is always smaller than the display data. For example, a display data with a size of ten bytes is stored in display buffer 408. Codec 416 compresses the display data to eight bytes, which is less than ten bytes. The extra two bytes provide sufficient buffer to guard against overwriting the portion of display data that has not been sent to RAM-integrated panel 610 for display.

In summary, the above described invention provides an apparatus, display controllers, and hardware implemented methods for sharing a display buffer between display data and compressed display data in a display controller. When compared to the conventional display controller having separate display buffer, codec buffer, and line buffer, eliminating the codec buffer and sharing the display buffer instead reduce memory size and reduce circuitry to encode and process the display data. For example, a conventional cell phone with a 160×160 LCD panel requires a display buffer of 50 kilobytes and a JPEG buffer of 50 kilobytes. As a result, the present invention can reduce the memory by half. The smaller the RAM-integrated panel, the higher proportion of memory can be saved. As a result, small, portable devices with limited power, memory, and computing capability incorporating the above described invention may process and encode photographic images faster, and the portable devices may also be made smaller as a result of the use of a smaller memory.

With the above embodiments in mind, it should be understood that the invention may employ various computer-implemented operations involving data stored in computer systems. These operations are those requiring physical manipulation of physical quantities. Usually, though not necessarily, these quantities take the form of electrical or magnetic signals capable of being stored, transferred, combined, compared, and otherwise manipulated. Further, the manipulations performed are often referred to in terms, such as producing, identifying, determining, or comparing.

Any of the operations described herein that form part of the invention are useful machine operations. The invention also relates to a device or an apparatus for performing these operations. The apparatus may be specially constructed for the required purposes, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

The above described invention may be practiced with other computer system configurations including hand-held devices, microprocessor systems, microprocessor-based or programmable consumer electronics, minicomputers, mainframe computers and the like. Although the foregoing invention has been described in some detail for purposes of clarity of understanding, it will be apparent that certain changes and modifications may be practiced within the scope of the appended claims. Accordingly, the present embodiments are to be considered as illustrative and not restrictive, and the invention is not to be limited to the details given herein, but may be modified within the scope and equivalents of the appended claims. In the claims, elements and/or steps do not imply any particular order of operation, unless explicitly stated in the claims.

1. A hardware implemented method for sharing a display buffer between display data and compressed display data in a display controller, comprising method operations of:
receiving the display data into the display buffer;
sending the display data for display on a random access memory (RAM)-integrated panel;
sending the display data to a codec for compression, the codec being configured to compress the display data to produce the compressed display data; and
overwriting the display data in the display buffer with the compressed display data prior to receiving a next display data.

2. The hardware implemented method of claim 1, further comprising:
sending the compressed display data stored in the display buffer to a central processing unit (CPU).

3. The hardware implemented method of claim 1, wherein the method operations of sending the display data for display on the RAM-integrated panel and sending the display data to a codec for compression occur simultaneously.

4. The hardware implemented method of claim 1, wherein the method operations of sending the display data for display on the RAM-integrated panel and sending the display data to a codec for compression occur sequentially.

5. The hardware implemented method of claim 1, wherein each method operation is repeated for each successive frame of the display data.

6. The hardware implemented method of claim 1, wherein the codec is selected from the group consisting of a Joint Photographic Experts Group (JPEG) codec, a Graphic Interchange Format (GIF) codec, and a Portable Network Graphics (PNG) codec.

7. A display controller having a shared memory, comprising:
a memory including a first memory block configured to alternate between storing display data and storing compressed display data; and
a codec in communication with the first memory block, the codec being configured to generate the compressed display data from the display data stored in the first memory block.

8. The display controller of claim 7, wherein the memory further includes,
a second memory block in communication with the first memory block and the codec, the second memory block being configured to store a portion of the display data.

9. The display controller of claim 8, wherein the second memory block is a line buffer.

10. The display controller of claim 7, further comprising:
a RGB to YUV converter (RYC) in communication with the first memory block and the codec.

11. The display controller of claim 7, wherein the display data is simultaneously sent to both a random access memory (RAM)-integrated panel for display and the codec for compression.

12. The display controller of claim 7, further comprising:
a YUV to RGB converter (YRC) in communication with the first memory block; and
a single resizer in communication with the YRC.

13. The display controller of claim 7, wherein the compressed display data is selected from the group consisting of Joint Photographic Experts Group (JPEG) data, Graphic Interchange Format (GIF) data, and Portable Network Graphics (PNG) data.

14. The display controller of claim 7, wherein the codec is selected from the group consisting of a Joint Photographic Experts Group (JPEG) codec, a Graphic Interchange Format (GIF) codec, and a Portable Network Graphics (PNG) codec.

15. The display controller of claim 7, wherein the first memory block is a display buffer.

16. An apparatus, comprising:
a display controller including,
circuitry for receiving display data into a display buffer,
circuitry for sending the display data for display on a random access memory (RAM)-integrated panel,
circuitry for sending the display data to a codec for compression, the codec being configured to compress the display data to produce the compressed display data, and
circuitry for overwriting the display data in the display buffer with
the compressed display data prior to receiving a next display data;
a central processing unit (CPU) in communication with the display controller; and
an image capture device in communication with the display controller.

17. The apparatus of claim 16, further comprising:
the RAM-integrated panel in communication with the display controller.

18. The apparatus of claim 17, wherein the RAM-integrated panel is selected from the group consisting of a RAM-integrated liquid crystal display (LCD), a RAM-integrated thin-film transistor (TFT) display, a RAM-integrated cathode ray tube (CRT) monitor, and a RAM-integrated television.

19. The apparatus of claim 16, wherein the display controller further includes,
circuitry for sending the compressed display data stored in the display buffer to the CPU.

20. The apparatus of claim 16, wherein the display controller further includes,
a memory configured to alternate between storing the display data and storing the compressed display data.
